(19) United States
(12) Patent Application Publication
(10) Pub. No.: US 2002/0188934 A1
(43) Pub. Date: Dec. 12, 2002

(54) Method and system for upgrading existing firmware on third party hardware

(75) Inventors: Robert R. Griffioen, Nepean (CA); Michael J. Garwood, Kanata (CA)

Correspondence Address: SMART AND BIGGAR, 438 UNIVERSITY AVENUE, SUITE 1500 BOX 111, TORONTO, ON, M5G2K8, CA

(73) Assignee: NORTEL NETWORKS LIMITED

(21) Appl. No.: 09/878,346

(22) Filed: Jun. 12, 2001

(51) Int. Cl. G06F 9/445

(52) U.S. Cl. 717/170; 717/173

(57) ABSTRACT

The present invention is directed at a method and system for upgrading existing firmware on third party hardware. The system initially receives identification information along with a firmware version indicator from the third party hardware. The identification information is then used to obtain a stored firmware version indicator representing the expected version of firmware which the third party hardware should be executing. The two firmware version indicators are compared and if they differ, an upgrade to the existing firmware is required. The system then retrieves the upgrade firmware from a remote location. The upgrade firmware is then stored in the third party hardware.

### FIELD OF THE INVENTION

The present invention relates in general to upgrading firmware and more specifically to a method and system for upgrading existing firmware on third party hardware.

### BACKGROUND OF THE INVENTION

Increasingly, hardware devices have associated software to provide desired functionality. This software is known as firmware or microcode. Firmware may be embedded into a read-only memory (ROM) in a hardware device. From time to time, it may be desirable to upgrade the firmware in order to improve the functionality of the hardware or add further functionality. If an upgrade to the firmware is required, the ROM must be replaced or, in the case of an erasable programmable ROM (EPROM), the EPROM must be completely erased, then re-programmed. While upgrading firmware in this way may be accomplished on an ad hoc basis in respect of a few hardware devices requiring infrequent upgrades, it becomes problematic for systems, such as some telephony systems, which have large numbers of hardware devices from different manufacturers requiring firmware upgrades on a fairly regular basis. To address this problem, known telephony systems may store all firmware relating to third party hardware devices in a master program located on a master processor rather than on the hardware devices themselves. Therefore, control of each piece of third party hardware is via the master processor. The firmware is integrated within the main software program used to operate a segment of the telephony system. When an upgrade is required, the entire system segment is shut down, the main software is re-written to include the upgraded firmware, and then the main software is re-compiled. The requirement for a system segment shut-down is far from optimal.

Therefore, there is provided an improved method and system for upgrading existing firmware on third party hardware.

### SUMMARY OF THE INVENTION

The present invention provides a method and system for upgrading existing firmware on third party hardware. After receiving identification information and a firmware version indicator from the third party hardware, a comparison may be performed to determine whether or not an upgrade is required for the existing firmware on the third party hardware. If an upgrade to the existing firmware on third party hardware is required, the system automatically upgrades the existing firmware by retrieving the upgrade firmware from a (remote) server and passing the upgrade firmware to the third party hardware to replace the existing firmware.

By automatically upgrading the existing firmware in real-time, the requirement of powering down the entire system in order to upgrade firmware on a single piece of third party hardware is avoided. Also, the present invention accommodates telephony systems with hardware from multiple third party manufacturers by communicating with various servers to download upgrade firmware form various third party manufacturers.

According to an aspect of the present invention, there is provided a method for upgrading existing firmware on third party hardware, including receiving identification information for the third party hardware and a firmware version indicator for the existing firmware on the third party hardware; utilizing the identification information to obtain a stored firmware version indicator for the third party hardware; comparing the received firmware version indicator with the stored firmware version indicator; and if the received firmware version indicator differs from the stored firmware version indicator, retrieving upgrade firmware for upgrading the existing firmware from a remote location.

According to another aspect of the system, there is provided a method for upgrading existing firmware on third party hardware, including: on power-up, sending a request to the third party hardware requesting identification information and an existing firmware version indicator; receiving a reply from the third party hardware with the identification information and the existing firmware version indicator; sending the identification information and the existing firmware version indicator addressed to an address; receiving an upgrade firmware version indicator and upgrade firmware; and transferring the upgrade firmware version indicator and the upgrade firmware to the third party hardware.

According to yet another aspect, there is provided a system for upgrading existing firmware on third party hardware, including a local area network (LAN) interface for connection to a LAN; a wide area network (WAN) interface for connection to a WAN; a memory for storing a database; a master processor operable to: receive identification information for the third party hardware from the LAN interface and a firmware version indicator for the existing firmware on the third party hardware; utilise the identification information to obtain a stored firmware version indicator for the third party hardware from the memory; and compare the received firmware version indicator with the stored firmware version indicator. If the received firmware version indicator differs from the stored firmware version indicator, new firmware for upgrading the existing firmware is retrieved from a remote location over the WAN interface.

According to yet another aspect of the invention, there is provided: a system for upgrading existing firmware on third party hardware, including means for receiving identification information for the third party hardware and a firmware version indicator for the existing firmware on the third party hardware; means for utilizing the identification information to obtain a stored firmware version indicator for the third party hardware; means for comparing the received firmware version indicator with the stored firmware version indicator; and means for, if the received firmware version indicator differs from the stored firmware version indicator, retrieving upgrade firmware for upgrading the existing firmware from a remote location.

In yet another aspect, there is provided a computer readable medium for providing computer executable instructions which, when executed on a processor interfaced with a local area network (LAN) to which a controller for third party hardware is connected and a wide area network (WAN) to which a source of upgrade firmware is connected, cause the processor to: receive identification information for the third party hardware from the LAN and a firmware version indicator for existing firmware on the third party hardware; utilise the identification information to obtain a stored firmware version indicator for the third party hardware from memory; compare the received firmware version indicator with the stored firmware version indicator; if the received firmware version indicator differs from the stored firmware version indicator, retrieve upgrade firmware for upgrading the existing firmware from the source over the WAN.

In a further aspect of the invention, there is provided a method for upgrading existing firmware on third party hardware connected to a local area network (LAN) through a controller utilising a wide area network (WAN) to which a source of upgrade firmware is connected, including receiving from the controller over the LAN identification information for the third party hardware and a firmware version indicator for the existing firmware on the third party hardware; utilising the identification information to obtain a stored firmware version indicator for the third party hardware; and comparing the received firmware version indicator with the stored firmware version indicator. If the received firmware version indicator differs from the stored firmware version indicator, new firmware for upgrading the existing firmware is retrieved from the source over the WAN.

Other aspects and features of the present invention will become apparent to those ordinarily skilled in the art upon review of the following description of a specific embodiment of the invention in conjunction with the accompanying figures.

### BRIEF DESCRIPTION OF THE DRAWINGS

The following figures illustrate, by example only, an embodiment of the invention:

FIG. 1 is a schematic diagram of a system for upgrading existing firmware on third party hardware.

FIGS. 2a to 2c are schematic diagrams of a protocol being utilized to send messages from the system to the third party hardware and vice-versa.

### DETAILED DESCRIPTION

The present invention is directed at a method and system for upgrading existing firmware on third party hardware. The system initially receives identification information along with a firmware version indicator from a third party hardware device. The identification information is then used to obtain a stored firmware version indicator representing the version of firmware which the third party hardware should be executing. The two firmware version indicators are compared and if they differ, an upgrade to the existing firmware is required. The system then retrieves the upgrade firmware from a remote location. The upgrade firmware is then passed to the third party hardware.

In the preferred embodiment, the method and system of the present invention may be implemented to automatically upgrade hardware components in a telephony system, whose firmware is maintained by external suppliers (or third parties). Upon power up of a controller for the third party hardware, the controller requests third party identification information and the existing firmware version number concerning the third party optical controller. This returned information is then used to determine if a firmware upgrade is required. If so, the upgrade is downloaded from a remote site and stored in the third party hardware component in order to upgrade the existing firmware. Upgrades of the third party hardware may also be initiated on demand.

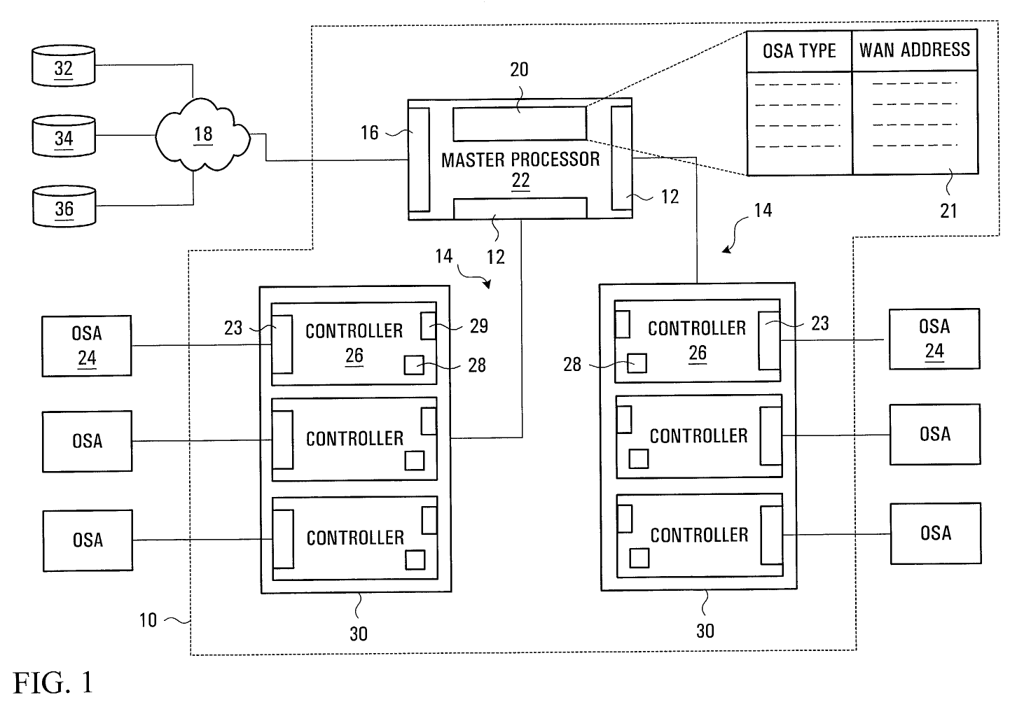

Turning to FIG. 1, a schematic overview of a system for upgrading existing firmware on third party hardware is shown and designated as 10. The system 10 includes a master processor 22 having a local area network (LAN) interface 12 for connection to a LAN 14 along with a wide area network (WAN) interface 16 for connection to a WAN 18. WAN 18 may be the public Internet or a telephone network. The system 10 also includes a memory 20, housed within master processor 22, for storing a database 21. The master processor may be referred to as an operations controller (OPC). The database stores a plurality of records each including identification information (identifying a third party manufacturer and a hardware device of such manufacturer), a firmware version indicator and a WAN address. Optionally, memory 20 may reside remotely from the OPC 22 provided it is in communication with the OPC 22 for communicating the contents of the records in the database. The system 10 communicates with the third party hardware devices 24, which in the exemplary embodiment of are optical spectrum analyzers (OSAs), via controllers 26. Each controller 26, which may be referred to as transport control subsystem (TCS), may be a card and have a serial interface 23 for communicating with an associated third party hardware device 24 and a processor 28. In this regard, as will be detailed hereinafter, each hardware device 24 is provided with the intelligence to respond to a certain set of messages. Each hardware device 24 stores its firmware in flash memory (i.e., an EPROM). Each controller (TCS) 26 also has an interface 29 for communicating with the OPC 22 over LAN 14 either directly or via a bay 30 in which the TCS is housed. In this regard, if LAN 14 is an Ethernet LAN, the OPC, each TCS and each bay may be addressable devices on the LAN. As shown, multiple controllers 26 may be housed within a single bay 30. The bays 30 may be network elements (NE) which provide software configuration upgrade/download (SCUD) capability.

As aforenoted, the OPC 22 is connected to the Wide Area Network (WAN) 18. This allows the OPC 22 to communicate with servers 32, 34 and 36 which store upgrade firmware in order to retrieve and store such firmware within the third party hardware 24, when required. WAN 18 may be the public Internet. The servers 32 or 34 may be remotely located at locations belonging to the third party manufacturers or may even be a server 36 located within the same site as the OPC 22. Each of the remote location servers 32 and 34 may store the upgrade firmware for third party manufacturer. Optionally, server 36 may store all upgrade firmware for each of the third party manufacturers. It will be understood that if this is the case, manufacturers of the third party hardware 24 controlled by the system 10 are required to provide upgrade firmware to server 36 on an ongoing basis.

In operation, an NE bay 30, with the controllers 26 it houses and their associated third party hardware devices 24 is typically powered down for maintenance once or twice per year. After receiving a power-up acknowledgement signal from the NE bay 30, which receives a power-up acknowledgement signal from the OPC 22, each controller 26 in the bay and its associated third party hardware device 24 are powered up. Each controller 26 is configured to send a request message to its associated third party hardware device 24 upon power up. The request message serves as a request for identification information, in the form of a manufacturer identifier and a part identifier (e.g. model number, part number or hardware version), and a firmware version indicator associated with the existing firmware on the third party hardware 24. The identification information and the indicator are then sent back from the third party hardware 24 to the controller 26 via a response message.

The communication between the controller 26 and the third party hardware 24 is via the serial interface, which in the preferred embodiment is a Universal Asynchronous Receive/Transmit (UART) interface.

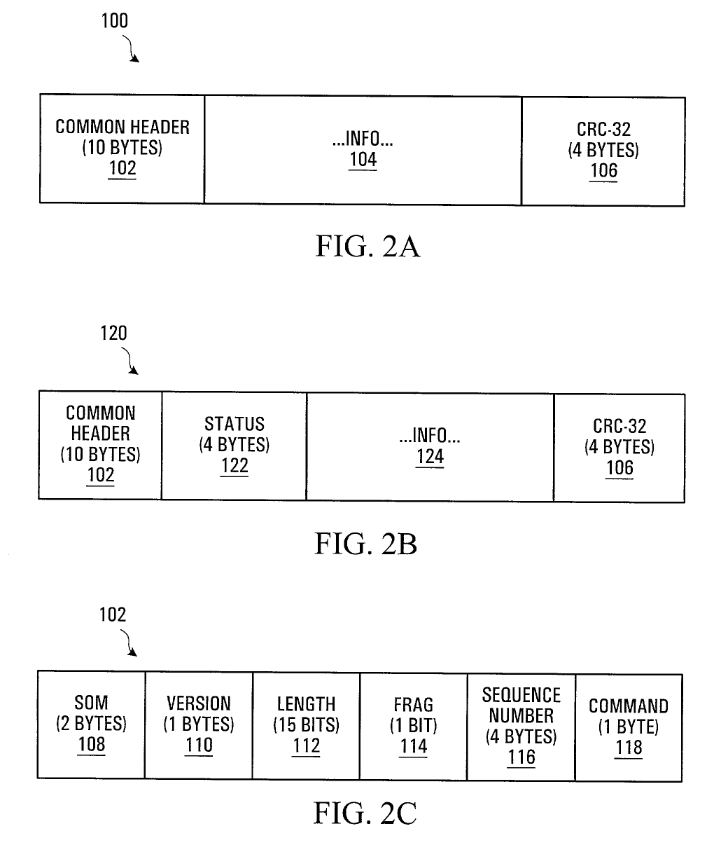

The controller 26 and the third party hardware 24 communicate using the messages shown in FIGS. 2a and 2b. To provide for this, the third party manufacturers are notified of the messaging protocol so that when the third party hardware 24 is manufactured, it is capable of handling the messaging protocol used by the controller 26.

After receiving the identification information and the firmware version indicator from the third party hardware 24, the controller 26 communicates these to the master processor 22. The master processor 22 then communicates with the memory 20 to obtain a stored firmware version indicator by using the identification information to query the database 21 for a record. A comparison is then performed between the firmware version indicators received form the third party hardware and the version indicator in the retrieved record. This may simply be a comparison between two strings with a floating point number. If the firmware version indicator received from the third party hardware 24 is the same as the stored firmware version indicator retrieved from the database 21, the existing firmware on the third party hardware 26 is confirmed to be the latest version and no upgrade is required. However, if the firmware version indicator received from the third party hardware differs from the stored firmware version indicator, an upgrade is required.

When an upgrade is required, the master processor 22 obtains an address of a remote location where the upgrade firmware may be retrieved for the retrieved record. Where WAN 18 is a public Internet, the stored address in the database record may be an Internet Protocol (IP) address for the remote location, pointing to one of servers 32, 34, or 36. The master processor 22 then connects with the server located at the stored IP address and retrieves the upgrade firmware via the WAN 18 using, for example, File Transfer Protocol (FTP). The upgrade firmware also includes an upgrade firmware version indicator. Alternatively, when WAN 18 is a telephone network, the stored address may be a telephone number such that communication between the master processor 22 and the server 32, 34, or 36 is over a dial-up connection.

Upon retrieval of the upgrade firmware by the master processor 22, the upgrade firmware, along with the upgrade firmware version indicator, is communicated from the master processor 22 to the controller 26. After the controller 26 receives the upgrade firmware, the firmware version indicator is first sent to hardware 24, then the firmware is transmitted from the controller 26 to the third party hardware 24 over the UART interface, preferably in 128 byte message fragments. The controller 26 begins by sending a command to command that the third party hardware copy the upgrade firmware to its flash memory. The controller 26 then transmits the fragments and specifies the address location within the flash memory where the upgrade firmware is to be stored. The initial address location is generally 0x00 and increments by one for each byte transferred over the UART interface. The 0x00 address indicates a new firmware download. After each fragment is transmitted, the third party hardware 24 may have a limited time to copy the upgrade firmware to the flash memory and to send a confirming reply message. After the controller 26 receives the confirming reply message, it sends the next fragment. When the controller 26 transmits the last firmware fragment, a message is transmitted to the third party hardware 24 to reset the third party hardware.

The upgrade firmware replaces the existing firmware on hardware 24 while the upgrade firmware version indicator replaces the previous firmware version indicator stored by hardware 24.

The format of each command message from a controller 26 and response message from hardware 24 is shown in FIGS. 2a and 2b, respectively. As shown in FIG. 2a, the command message 100 includes a common header section 102, an “info” section 104 and a cyclic redundancy check section 106. The command message 100 is preferably up to 128 bytes long. The “info” section 104 is variable in length for storing user message data. For example, the “info” section 104 of the command message 100 sent whenever controller 26 is powered up is a request for the identification information along with the firmware version indicator of the existing firmware on the third party hardware 24.

As shown in FIG. 2c, the common header section 102 contains a start of message (SOM) section 108, a version section 110, a length section 112, a “frag” section 114, a sequence number section 116 and a command section 118. The SOM section 108 is a 16-bit section which indicates the start of a new message being sent from the controller to the third party hardware. The version section 110 is an 8-bit section which specifies the generic of the message protocol. The length section 112 is a 15-bit section which specifies the length of the message. The “frag” section 114 is a 1-bit section which indicates whether the message is an entire message or simply a fragment of the request message. The sequence number section 116 is a 32-bit section which specifies the message sequence number and is incremented each time a command or response message is sent. The command section 118 is an 8-bit section which is set by the controller to specify the specific command made to the third party hardware. For example, the command for requesting identification information may be a “GetSubassemblyData” command represented numerically as 0x02. Finally the CRC-32 section 106 is a 32-bit section which permits the receiving end to determine if there was a transmission error.

As for the response message 120 of FIG. 2b, the message 120 includes the common header section 102 a status section 122, an “info” section 124 and a cyclic redundancy check section 106. The status section 122 is a 32 bit section set by the third party hardware to specify the results of command processing (success or failure) and, if failure, an error code indicating the reason. It will be understood that the command section 118 of the request message is not amended by the third party hardware.

For the response message 120, the info section 124 contains the reply to the command. Thus, in response to a “GetSubassemblyData” command, the “info” section 124 of response message 120 will have identification information, indicating, for instance, the manufacturer of the third party hardware, along with the firmware version indicator showing the version of the existing firmware on the third party hardware 24.

One of the advantages of the present invention is that the firmware necessary to operate the third party hardware 24 is located on the third party hardware. Therefore, when an upgrade is required, only the third party hardware requiring the upgrade is shut down in order to upgrade the existing firmware. This avoids the requirement of shutting down the entire system simply to upgrade the firmware on one piece of third party hardware. Furthermore, any software executed by the master processor 22 is not affected by firmware upgrades.

It will be understood that although the present invention has been described with respect to telephony systems and more specifically with the third party hardware being OSAs, the present invention may be included in any type of system which requires firmware upgrades. In this regard, the hardware devices may be other digital signal processors (DSP) or circuit packs.

In order to add a new third party hardware device to the system, the identity of the third party manufacturer along with the latest firmware version and an IP address representing the remote location to retrieve the upgrade firmware must be initially stored in the database 21 located in memory 20. The new third party hardware 24 is then connected to a free controller 26 via a serial interface. Of course, the new hardware device 24 must be capable of handling the described command messages from the controller. After the connection has been completed, the third party hardware may be powered up and operation of the system, as described above, commenced.

Each NE bay 30 provides a secondary level to handle a large number of controllers 26 with a system 10. It will therefore be understood that although the preferred embodiment has a NE bay 30 for housing controllers 26, the NE bay is not necessary for operation. The master processor 22 may instead communicate directly with each controller 26 in a master-slave relationship. Moreover, the master processor 22 may communicate directly with the third party hardware 24, however, the addition of controllers 26 reduces the load for the master processor 22.

Preferably, each controller 26 manages a single third party hardware device 24.

It will be understood that if a version indicator received with respect of a hardware device 24 does not match that stored in database 21 for the device 24, an immediate upgrade is initiated. For optimum performance, the database should be periodically, or constantly, updated from the third party manufacturers with the latest firmware version indicators for given hardware so that it can be assumed the latest version of firmware for third party hardware is reflected by the database.

It will be understood that not only does the present invention overcome the problems attributed to firmware upgrading in the past but also supports multi-sourcing of third party hardware, provides automatic and real-time upgrading of existing firmware on third party hardware, allows the master processor to continuously operate with the same main program which does not have to re-compiled and allows for easy integration of new third party hardware within the system without having to affect the overall system.

Also, although only one master processor 22 is shown, multiple master processors 22 may be included in the system 10. Moreover, each master processor 22 may be capable of handling, for example, thirty four bays 30 while each bay 30 may be capable of handing, for example, up to twenty controllers 26.

Optionally, the TCS card 26 may store the upgrade firmware version indicator instead of communicating it to the third party hardware device. In this case, if the controller also stores the identification information, then upon power up, the OPC 22 may communicate with the controller 26 for the identification information and the firmware version indicator without the requirement of the controller sending a request message to the third party hardware device 24.

Although a controller 26 has been described as sending a request message to the hardware device 24 on power-up, optionally the controller may send such message whenever prompted to do so by its NE bay 30 or by OPC 22 (i.e., on demand) or at periodic time intervals.

The above-described embodiments are intended to be illustrative only, and in no way limiting. The embodiments are susceptible to many modifications of form, size, arrangement of parts and details and order of operation. The invention, rather, is intended to encompass all such modifications within its scope as defined by the claims.

What is claimed is:

1. A method for upgrading existing firmware on third party hardware, comprising:
receiving identification information for said third party hardware and a firmware version indicator for said existing firmware on said third party hardware;
utilising said identification information to obtain a stored firmware version indicator for said third party hardware;
comparing said received firmware version indicator with said stored firmware version indicator;
if said received firmware version indicator differs from said stored firmware version indicator, retrieving upgrade firmware for upgrading said existing firmware from a remote location.

2. The method of claim 1 wherein said utilising said identification information is also to obtain a stored address which addresses said remote location and wherein said retrieving comprises connecting to said remote location as specified by said address.

3. The method of claim 2 wherein said address is an Internet Protocol (IP) address.

4. The method of claim 1 further comprising upgrading said existing firmware with said upgrade firmware.

5. The method of claim 4 wherein said upgrading comprises sending said upgrade firmware to a controller for said third party hardware.

6. The method of claim 4 wherein said retrieving also comprises retrieving an upgrade firmware version indicator.

7. The method of claim 5 wherein said retrieving also comprises retrieving an upgrade firmware version indicator and wherein said upgrading further comprises sending said upgrade firmware version indicator to said controller.

8. The method of claim 2 wherein said utilising comprises querying a database with said identification information for a record having said stored version indicator and said stored address.

9. The method of claim 8 further comprising receiving said database, said database having a plurality of records each comprising identification information, a version indicator, and an address.

10. The method of claim 2 wherein said identification information comprises a manufacturer identifier and a part identifier.

11. The method of claim 8 wherein said stored version indicator is a stored version number and wherein said received version indicator is a received version number.

12. The method of claim 6 wherein said upgrading comprises sending upgrade messages to said third party hardware over a serial link to transfer said upgrade firmware version indicator and said upgrade firmware to said third party hardware.

13. The method of claim 12 wherein each upgrade message comprises a fragment indicator to indicate whether or not said each upgrade message is the last upgrade message in a sequence of upgrade messages for transferring said upgrade firmware and said upgrade firmware version indicator.

14. The method of claim 13 further comprising awaiting a reply message after sending said each upgrade message.

15. A method for upgrading existing firmware on third party hardware, comprising:
sending a request to said third party hardware requesting identification information and an existing firmware version indicator;
receiving a reply from said third party hardware with said identification information and said existing firmware version indicator;
sending said identification information and said existing firmware version indicator addressed to an address;
receiving an upgrade firmware version indicator and upgrade firmware;
transferring said upgrade firmware version indicator and said upgrade firmware to said third party hardware.

16. The method of claim 15 further comprising:
before said sending, comparing said existing firmware version indicator with a stored firmware version indicator and sending only if said existing firmware version indicator differs from said stored firmware version indicator.

17. The method of claim 15 wherein said sending a request comprises sending a request on power-up.

18. A system for upgrading existing firmware on third party hardware, comprising:
a local area network (LAN) interface for connection to a LAN;
a wide area network (WAN) interface for connection to a WAN;
a memory for storing a database;
a master processor operable to:
receive identification information for said third party hardware from said LAN interface and a firmware version indicator for said existing firmware on said third party hardware;
utilise said identification information to obtain a stored firmware version indicator for said third party hardware from said memory;
compare said received firmware version indicator with said stored firmware version indicator;
if said received firmware version indicator differs from said stored firmware version indicator, retrieve upgrade firmware for upgrading said existing firmware from a remote location over said WAN interface.

19. The system of claim 18 further comprising:
a controller for said third party hardware having a controller LAN interface, a serial interface for connection to said third party hardware, and a controller processor

20. The system of claim 19 wherein said controller processor is operable to:
send a request message to said third party hardware interface requesting identification information and a firmware version indicator;
receive a reply message over said third party hardware interface with said identification information and said firmware version indicator;
send said identification information and said firmware version indicator from said controller LAN interface addressed to an address for said master processor;
receive an upgrade firmware version indicator and upgrade firmware over said controller LAN interface;
send upgrade messages to said third party hardware interface in order to send said upgrade firmware version indicator and said upgrade firmware over said third party hardware interface.

21. The system of claim 20 wherein said controller processor is operable to send said request on power-up.

22. A system for upgrading existing firmware on third party hardware, comprising:
means for receiving identification information for said third party hardware and a firmware version indicator for said existing firmware on said third party hardware;
means for utilising said identification information to obtain a stored firmware version indicator for said third party hardware;
means for comparing said received firmware version indicator with said stored firmware version indicator;
means for, if said received firmware version indicator differs from said stored firmware version indicator, retrieving upgrade firmware for upgrading said existing firmware from a remote location.

23. A computer readable medium for providing computer executable instructions which, when executed on a processor interfaced with a local area network (LAN) to which a controller for third party hardware is connected and a wide area network (WAN) to which a source of upgrade firmware is connected, cause said processor to:
receive identification information for said third party hardware from said LAN and a firmware version indicator for existing firmware on said third party hardware;
utilise said identification information to obtain a stored firmware version indicator for said third party hardware from memory;
compare said received firmware version indicator with said stored firmware version indicator;
if said received firmware version indicator differs from said stored firmware version indicator, retrieve upgrade firmware for upgrading said existing firmware from said source over said WAN.

24. A method for upgrading existing firmware on third party hardware connected to a local area network (LAN) through a controller utilising a wide area network (WAN) to which a source of upgrade firmware is connected, comprising:
receiving from said controller over said LAN identification information for said third party hardware and a firmware version indicator for said existing firmware on said third party hardware;
utilising said identification information to obtain a stored firmware version indicator for said third party hardware;
comparing said received firmware version indicator with said stored firmware version indicator;
if said received firmware version indicator differs from said stored firmware version indicator, retrieving upgrade firmware for upgrading said existing firmware from said source over said WAN.
